(19) United States
(12) Patent Application Publication
(10) Pub. No.: US 2007/0011044 A1
(43) Pub. Date: Jan. 11, 2007

(54) Discount applications with registered payment instruments

(75) Inventor: Kurt Hansen, Castle Rock, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Englewood, CO (US)

(21) Appl. No.: 11/176,576

(22) Filed: Jul. 6, 2005

(51) Int. Cl. G06Q 30/00

(52) U.S. Cl. 705/14

(57) ABSTRACT

Methods and systems provide a discount to a transaction executed between a customer and a merchant for a purchase of goods and/or services. An electronic information packet is received at a host system. The electronic information packet includes an identifier of a credit instrument presented by the customer to the merchant and registered with the host system. The electronic information packet also includes transaction information identifying at least some of the goods and/or services. An authorization request is transmitted from the host system to a credit provider associated with the credit instrument. An approval for the transaction is received with the host system from the credit provider. The approval is transmitted with the host system to the merchant. Separate discounts available for application to the transaction for the customer are identified with the host system and from the identifier. A modified transaction having a total transaction cost reduced by application of at least one of the separate discounts is coordinated between the host system and the merchant.

### BACKGROUND OF THE INVENTION

This application relates generally to discount applications. More specifically, this application relates to discount applications with registered payment instruments.

In recent years, there has been a general increase in the availability and sophistication of discount arrangements. Discounts on goods and/or services are frequently offered to consumers to act as incentives in encouraging those consumers to make specific purchases. A traditional form of a discount is provided in the form of a coupon, which is a paper instrument that is presented to a merchant by the customer at the time of purchasing an identified product so that the cost of the product will be discounted. Coupons are frequently distributed to customers in newspapers, magazines, and periodicals. These types of discounts usually originate with the manufacturers of the products being discounted, with the manufacturer being responsible for the discount. A number of variations on these types of discounts are known in the art, such as where discounts are provided only for the purchase of certain combinations of products, only for the purchase of certain sizes of products, only for the purchase of products within a specified time period or on a particular day of the week, and the like. In most cases, the requirement to clip and present paper coupons detracts from the desired inducement—in most cases, the intent is to induce the customer to purchase a particular product by making the discount available.

Other discount arrangements may place responsibility for the discount on parties other than the manufacturer. For example, some merchants may offer across-the-board discounts for goods and/or services purchase at their merchant locations. In such instances, the merchant would provide a discount of a certain amount, say 10%, for an entire purchase of a variety of different goods originating with various manufacturers. Some merchants currently provide automatic discounts to all customers who allow their shopping behavior to be monitored by issuing customers a magnetic-stripe card. At each transaction, the customer presents the card, allowing the merchant to track purchases by the customer, in exchange for which the automatic discounts for those qualifying products are applied. In still other instances, a discount may be provided by a credit company or financial institution as an inducement to use a particular credit or debit card.

In different cases, there may or may not be restrictions imposed on the ability to combine various discount arrangements. These restrictions might be imposed by any of the different parties responsible for one of the discounts, such as where a manufacturer indicates that a discount on a product cannot be combined with any other offer. In other instances, combining offers may be encouraged, such as in cases where a merchant offers to double the value of any coupon used with that merchant.

The wide variety in discount arrangements and the increasing complexity in their interaction causes there to be a general need in the art for improved methods and systems of processing discount arrangements.

### BRIEF SUMMARY OF THE INVENTION

Embodiments of the invention thus provide methods and systems for providing a discount to a transaction executed between a customer and a merchant for a purchase of goods and/or services. In a first set of embodiments, an electronic information packet is received at a host system. The electronic information packet includes an identifier of a credit instrument presented by the customer to the merchant and registered with the host system. The electronic information packet also includes transaction information identifying at least some of the goods and/or services. An authorization request is transmitted from the host system to a credit provider associated with the credit instrument. An approval for the transaction is received with the host system from the credit provider. The approval is transmitted with the host system to the merchant. A plurality of separate discounts available for application to the transaction for the customer are identified with the host system and from the identifier. A modified transaction having a total transaction cost reduced by application of at least one of the plurality of separate discounts is coordinated between the host system and the merchant.

In a second set of embodiments, an electronic information packet is received at a host system operated by a discount coordinator. The electronic information packet includes an identifier of a discount instrument presented by the customer to the merchant and purchased for a fee from the discount coordinator. A discount instrument purchased for a fee from the discount coordinator may sometimes be purchased at the merchant location, but is otherwise purchased at a separate location. The electronic information packet also includes transaction information identifying at least some of the goods and/or services. A plurality of separate discounts available for application to the transaction for the customer are identified with the host system and from the identifier. A modified transaction having a total transaction cost reduced by application of at least one of the plurality of separate discounts is coordinated between the host system and the merchant.

In either set of embodiments, there are a number of different ways in which the modified transaction may be coordinated. For example, in some cases a list of the plurality of separate discounts is transmitted from the host system to the merchant for display to the customer. Such transmission may sometimes be performed in real time when the customer is at the merchant, or may be done in batch mode periodically from the host system to a point-of-sale device at the merchant location. A selection by the customer of one of the plurality of separate discounts is received, and the total transaction cost reduced by the selected discount is calculated. In other cases, one of the plurality of discount accounts is identified with the host system as most advantageous for the customer among the plurality of separate discounts, and the total transaction cost reduced by the identified one of the plurality of discounts is calculated. For instance, the most advantageous discount might reduce the total transaction cost by a greater amount than any others of the plurality of separate discounts. In still other instances, multiple discounts eligible for simultaneous application are identified with the host system, and the total transaction cost reduced by the identified multiple discounts is calculated.

The at least of the plurality of separate discounts may comprise a discount offered by the merchant or may comprise a discount offered by a manufacturer of one of the goods and/or services in different embodiments. In some embodiments, settlement of the at least one of the separate discounts is initiated by the host system by initiating a funds transfer to compensate the merchant for application of the at least one of the separate discounts to the transaction. The settlement may be performed as part of a batch process initiating settlement of discounts for a plurality of transactions between a plurality of customers and a plurality of merchants.

The methods of the present invention may be embodied in a computer-readable storage medium having a computer-readable program embodied therein for directing operation of the host system. The host system may include a communications device, a storage device, a processor, and a memory. The memory is coupled with the processor and comprises the computer-readable storage medium. The computer-readable program includes instructions for operating the host system to provide a discount to a transaction executed between a customer and a merchant for a purchase of goods and/or services in accordance with the embodiments described above.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sublabel is associated with a reference numeral and follows a hyphen to denote one of multiple similar components. When reference is made to a reference numeral without specification to an existing sublabel, it is intended to refer to all such multiple similar components.

FIG. 1 provides a schematic representation of the interaction of various physical elements in embodiments of the invention;

FIGS. 2A-2D are flow diagrams summarizing various methods of the invention that may be implemented using the structure shown in FIG. 1;

FIG. 3 is a flow diagram summarizing other methods of the invention that may be implemented using the structure shown in FIG. 1; and

FIG. 4 is a schematic illustration of a structure for a host system on which methods of the invention may be embodied.

### DETAILED DESCRIPTION OF THE INVENTION

Embodiments of the invention permit the availability of multiple different discount arrangements available for a single transaction to be accommodated. Such multiple arrangements are accommodated by processing transactions through a centralized discount coordinator that is itself in communication with a variety of different related systems to identify discounts and perhaps also select which of the multiple discounts to apply. In some embodiments, this activity is coupled with coordinating payment for the transaction by using information from a credit instrument that has been registered with the discount coordinator. In other embodiments, a different registered instrument may be used to access benefits of the system; in some cases, this instrument is provided to the customer as a result of a purchase, providing a mechanism by which a customer may have anonymous access to automatic discount arrangements.

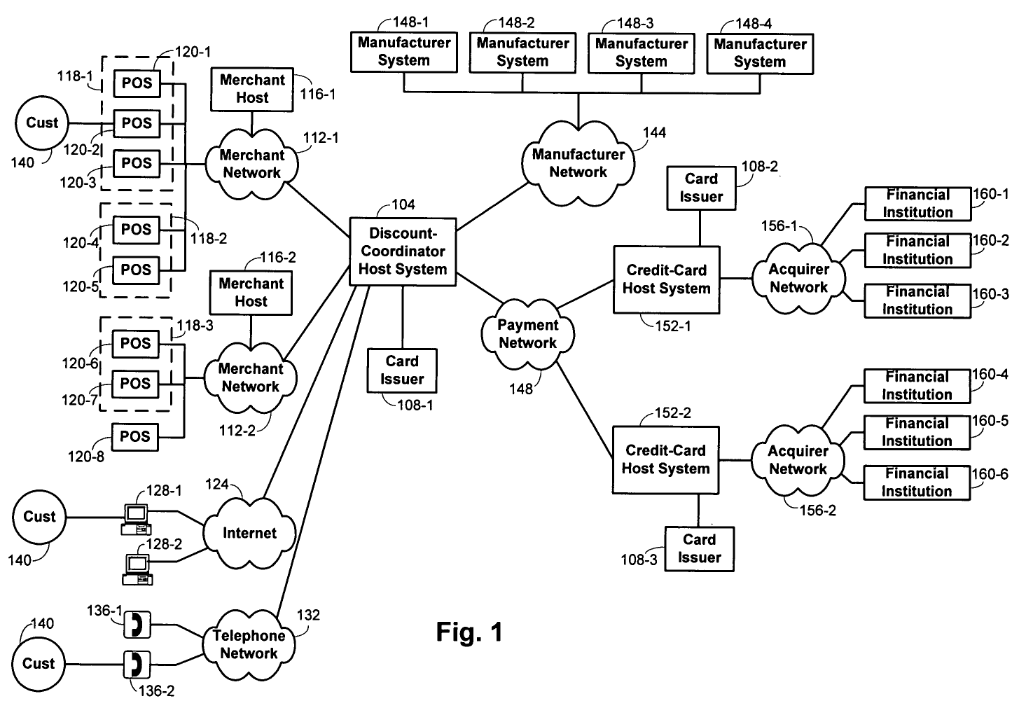

An overview of a system that may be used in implementing embodiments of the invention is provided with the schematic diagram shown in FIG. 1. Functions performed by the discount coordinator are implement with a discount-coordinator host system 104, which is a computer system having communications links with other types of computer systems over a variety of networks. Several of these networks permit the discount-coordinator host system 104 to receive transaction information during a transaction between a customer and a merchant. For example, it is expected that most transactions between customers 140 and merchants will take place at a physical point of sale, such as at a merchant store. Transaction information is collected during the transaction from a point-of-sale device 120 equipped with physical elements that may extract transaction information. For example, the point-of-sale device may include a bar-code reader used to read product bar codes and determine the base price for the products from a database. The point-of-sale device may also include magnetic-stripe readers used to read a magnetic stripe comprised by the registered instrument, or may include other types of readers depending on the form of the registered instrument, such as smart-card readers and the like.

There are a number of different architectures that may be used to effect communications between the discount-coordinator host system 104 and the individual point-of-sale devices. The exemplary illustration in FIG. 1 shows, for example, that the individual point-of-sale devices 120 may be provided with communications links with a merchant network 112, which is itself in communication with the discount-coordinator host system 104. The illustration shows multiple merchant networks 112, reflecting the fact that individual merchants may have their own networks segregated from other merchant networks, potentially operated by competitors. Each merchant network 112 may additionally be provided in communication with a merchant host 116, which is a computer system used to implement various merchant functionality. Each merchant may additionally have multiple point-of-sale devices 120 at a single merchant location, such as where a merchant location has multiple checkout stations where customers may execute transactions. This is indicated in the drawing by grouping certain point-of-sale devices 120 collectively as an identified group 118 of devices, each of which is at the same merchant location. In some instances, a merchant location might have only a single point-of-sale device, as indicated by point-of-sale device 120-8. In addition, while each of the merchants shown in FIG. 1 have multiple locations that have point-of-sale devices where customers 140 may execute transactions, there may also be single-location merchants that provide one or more point-of-sale devices only at a single merchant location.

Customers 140 may also execute transactions through other types of interfaces with a particular merchant, examples of which include the Internet 124 and telephone networks 132. For instance, a customer might enter into a transaction with a merchant by establishing an Internet connection through a computer 128 to access a web site of the merchant and thereby place an order. The interface is generally equipped to collect the same kind of transaction information as an on-site point-of-sale device, but may require that the customer 140 enter a credit-card number and other information rather than using a local read device to collect such information. The telephone interface may function similarly, with a customer 140 accessing a live or automated service through his telephone 136 to place an order for a product. Voice-recognition software might be used so that the customer 140 could verbally convey a credit-card number and similar information, or dual-tone multiple-frequency capability of his telephone 136 might be used to transmit such information.

In addition to having connections with these various interfaces to collect transaction information, the discount-coordinator host system 104 may also be provided in communication with other interfaces that provide access to discount information. For example, the discount-coordinator host system 104 may be interfaced with one or more manufacturer systems 148 through one or more manufacturer networks 144. Each manufacturer system 148 may summarize information specifying which discounts a corresponding manufacturer is offering as an inducement to purchase that manufacturer's products. This information may include any restrictions on the discount, such as that a particular product size be purchased, that the transaction be executed within certain defined dates, that the discount be applied only to a limited number of products, that the discount be applied only if certain combinations of products are purchased, and the like.

Other discount information may be accessed from the merchant systems, such as from the merchant hosts 116 through the merchant networks 112. Information from these sources generally identifies discounts that apply for making purchases from a particular merchant as an inducement for customers to shop there. Again, the information may include an identification of any applicable restrictions, such as that the discount apply only if a certain total transaction amount is reached, that the transaction be executed within certain defined dates, and the like. In some instances, the merchant discounts identified in this way may be for particular products, such as might be offered as a mechanism for a merchant to more quickly reduce its inventory levels of slow-moving merchandise. In these kinds of circumstances, a particular product may qualify for multiple discounts, i.e. a discount provided by the manufacturer and a separate discount provided by the merchant, in which case the respective sources of information may identify any restrictions on combining discount offers.

The use of the merchant hosts 116 as a source of discount information illustrates that some of the interfaces with the discount-coordinator host system 104 may have multiple functions. This is true of the merchant networks 112, which provide a mechanism for the exchange of transaction information with the discount-coordinator host system 104 and also provide a mechanism for accessing certain discount information. Such multifunctionality may also be provided by payment networks 148 that are used in seeking approval for execution of transactions using credit or debit instruments. For example, some credit suppliers might offer discounts to customers who use their credit instruments in executing a transaction, advertised as a “cash-back” or similar feature. Information regarding the availability of such discounts may be received over the payment network 148 from credit-card host systems 152 for different credit agencies.

As previously suggested, the credit-card host systems 152 may also be involved in approving transactions that make use of credit arrangements as a source of funds. A credit supplier may act as an acquirer that coordinates the availability of credit from a number of different financial institutions 160, with an acquirer network 156 providing a interface mechanism between the credit-card host system 152 and the financial institutions 160. Approval for a particular credit transaction may involve routing an authorization request at least to the credit-card host system for application of a rules-based approval mechanism and might sometimes additionally involve routing certain information to one of the financial institutions. While the specific examples shown in FIG. 1 are for credit suppliers, a similar organization of networks may be used in alternative embodiments for debit transactions, i.e. transactions whose approval is dependent on confirmation that there are sufficient funds in a defined account to support the transaction.

Identification of a particular customer's credit account is commonly performed with a plastic card, although other embodiments of the invention may use other forms of instruments. Accordingly, the credit-card host systems 152 may be in communication with respective card-issuer systems 108 to coordinate generation and mailing of the cards to customers. The card issuer 108 is usually provided with the information to be embossed on a card and magnetically encoded on a magnetic stripe affixed to the back of the card, and uses this information to produce the card and initiate its mailing to a customer. In several embodiments of the invention, the customer's credit instrument is used as the registered payment instrument, and so may originate with one of the card issuers 108-2 or 108-3 used by the credit associations. In other embodiments, the registered instrument may be provided directly by the discount coordinator, in which case the instrument may originate with a card issuer 108-1 used by the discount coordinator.

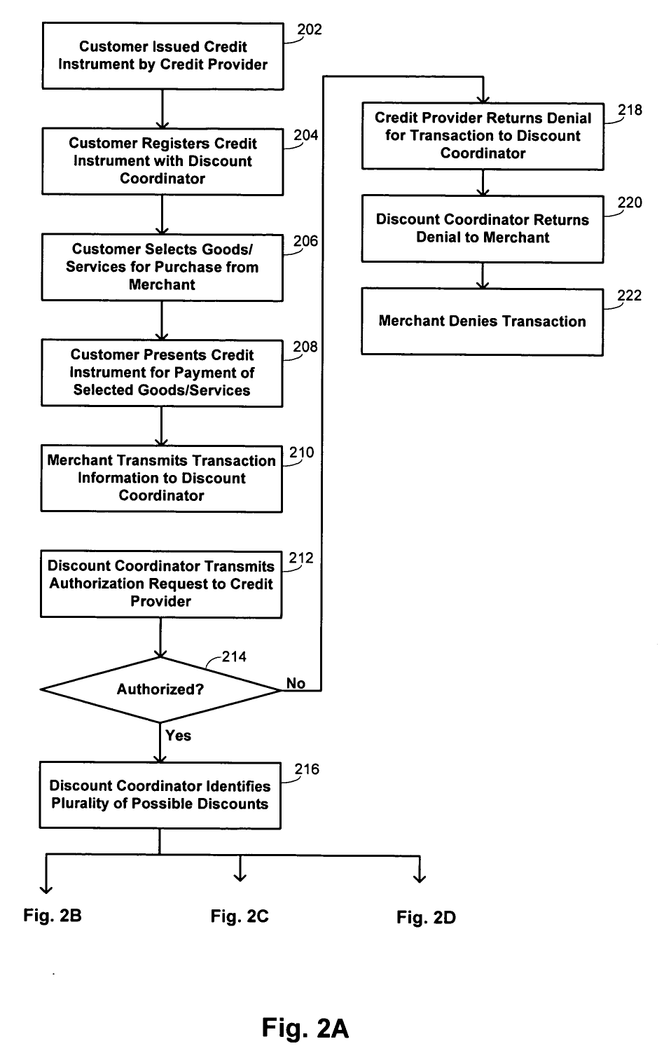

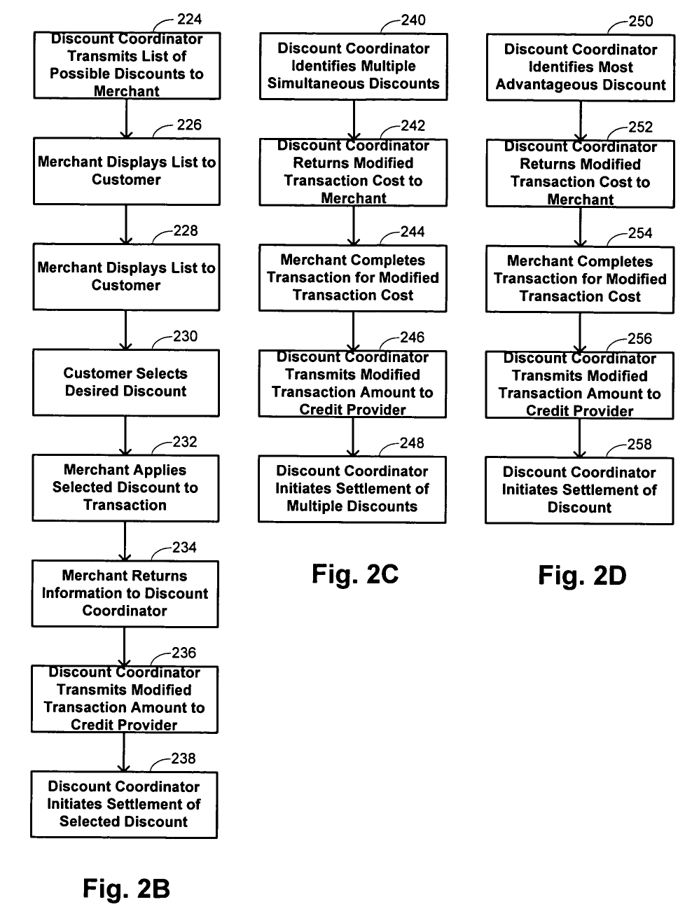

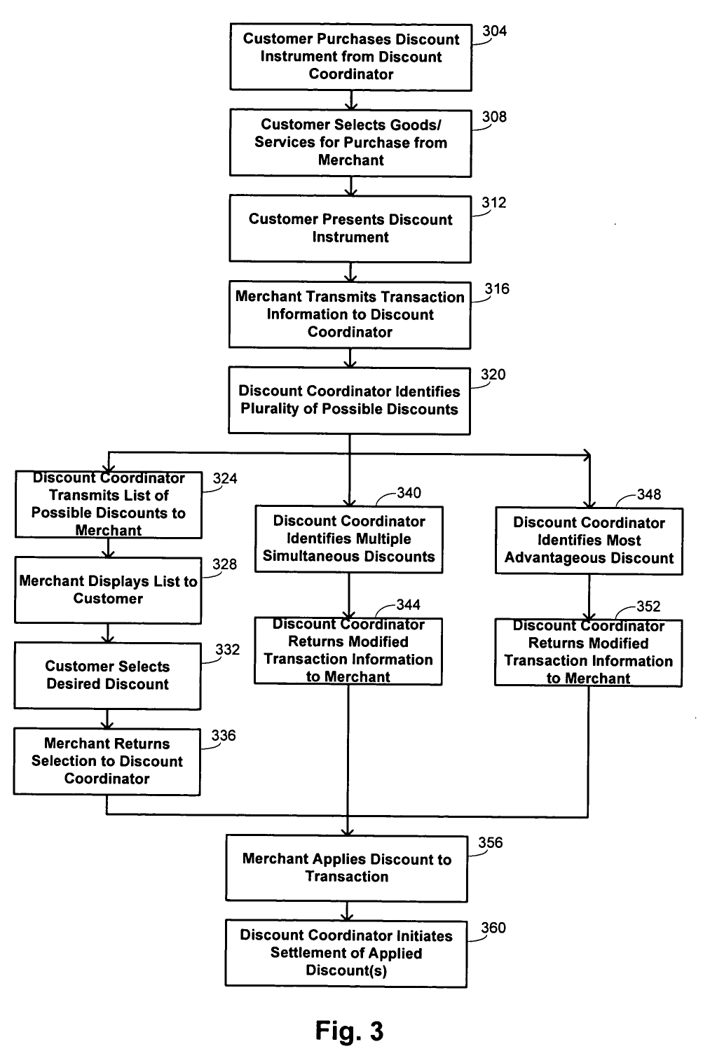

The exemplary architecture of FIG. 1 may be used in implementing a number of different methods of the invention, some of which are illustrated with the flow diagrams of FIGS. 2A-2D and FIG. 3. The flow diagrams of FIGS. 2A-2D correspond generally to embodiments in which the registered instrument comprises a credit instrument, while the flow diagram of FIG. 3 corresponds generally to embodiments in which the registered instrument is a specially issued instrument. Although the flow diagrams set forth one order for performing certain functions, this ordering is not intended to be restrictive and the functions may be performed in a different order in alternative embodiments. Furthermore, the identification of specific functions that are performed is intended to illustrate particular embodiments, but it will be recognized that certain additional functions may be performed without exceeding the intended scope of the invention and that certain identified functions may be omitted in some embodiments without exceeding the intended scope of the invention.

Thus, methods of the invention may begin as indicated at block 202 of FIG. 2A with the customer being issued a credit instrument by a credit provider. Such a credit instrument frequently takes the form of a magnetic stripe card, but may in alternative embodiments comprise a smart card, an RFID device, or even simply an identifier assigned to the customer. The instrument is a credit instrument because it identifies the customer as authorized to access a credit account for funds to be used in executing transactions. The credit account is established on the basis of the creditworthiness of the customer and may have an assigned credit limit that the customer may access. As such, the credit instrument may be a conventional type of credit instrument and may be issued by the credit provider without any knowledge of discount arrangements that may be accessed as described herein.

To make use of aspects of the invention, the customer registers the credit instrument with the discount coordinator at block 204. Such registration may be accomplished in a variety of different ways in several embodiments, including registration over the Internet 124 using a computer 128 access, registration through a telephone network 132 using a telephone 136 access, or registration at a merchant point-of-sale who participates in the program offered by the discount coordinator. In some embodiments, registration may be accomplished through the credit provider. Essentially any communications mechanism that may be established between the discount coordinator and the customer may be used to effect registration of the credit instrument, including the various communications mechanisms illustrated in FIG. 1 and including other mechanisms, such as postal communication, in-person registration at an office of the discount coordinator, and the like.

One the credit instrument has been registered, its use as part of a transaction with a merchant may automatically provide the customer with discount benefits as a consequence of the arrangement described in connection with FIG. 1. The customer initiates a transaction with a merchant by selecting goods and/services for purchase at block 206, whether such selection be in person at a merchant location, over the Internet, by telephone, or otherwise, and presents the registered credit instrument for payment of the selected goods and/or services at block 208. Transaction information, which may include such information as the total cost for the transaction, a specification of each of the products to be purchased, an identification of the merchant, an identification of an account number extracted from the credit instrument, and the like, is transmitted from the merchant system to the discount-coordinator host system 104 at block 210.

Part of the processing performed by the discount-coordinator host system 104 is conventional for any credit transaction. That is, as part of its functionality, the discount-coordinator hast system 104 seeks an authorization for the transaction amount in accordance with the customer's credit agreement and returns an authorization or denial back to the merchant system so that the transaction may be completed or refused as appropriate. Thus, at block 212, the discount coordinator transmits the authorization request over a payment network 148 to the credit provider identified by the credit instrument. If the transaction is not to be authorized, as checked at block 214, the credit provider will return a denial code for the transaction back to the discount coordinator at block 218. The discount coordinator correspondingly returns a denial code back to the merchant at block 220 so that the merchant will deny the transaction at block 222.

If the transaction is to be authorized, embodiments of the invention are invoked upon the identification by the discount coordinator of a plurality of possible discounts that may apply to the transaction at block 216. The identification of such possible discounts arises from the communications connections provided to the discount-coordinator host system 104 to identify potential manufacturer discounts, potential merchant discounts, potential credit-provider discounts, and perhaps other discounts. Some discounts may be time based, while other discounts may be based on an amount to be saved. There are a variety of different actions that may subsequently be taken by the discount-coordinator host system 104 depending on the embodiment. These different actions are described respectively in connection with FIGS. 2B, 2C, and 2D as indicated at the bottom of FIG. 2B. In addition to that description, embodiments of the invention may include automatic remittance of rebate discounts on behalf of the customer, either physically or electronically. The rebate could then be transmitted to the customer at a registered address or assigned to the retailed by the customer and applied to a subsequent purchase.

In one embodiment, reflected in the flow diagram of FIG. 2B, the customer 104 is provided with the ability to select among the plurality of possible discounts. The discount coordinator accordingly transmits a list of the possible discounts to the merchant system at block 224, allowing the merchant system to display the list to the customer 104 at block 228. The list may be accompanied with an authorization code indicating to the merchant that the transaction is approved up to the total amount of the transaction so that the application of any discounts will not affect the approval of the transaction. In response to the customer selected a desired discount from the displayed list at block 230, the merchant may accordingly apply the selected discount to the transaction at block 232.

In other embodiments, selection from among multiple possible discounts may be accomplished by providing the customer with a registered proximity device, such as an RFID device. As the customer approached items for sale, or for which discounts could be applied, the proximity device would be detected so that the customer could be informed of the discount. Such notification to the customer may be provided by a visual cue, such as an LED or LCD display, or by an acoustic cue, such as a directionally modulated sound to ensure the cue is directed towards the customer. Alternatively, a smart shopping cart could be equipped with the proximity device and may have notification media embedded therein. In such embodiments, customers would identify themselves to the smart cart so that levels of discounts applicable would be triggered as the card is used. Such an embodiment advantageously permits the customer to keep a running total of savings as each item is identified as it is placed in the cart.

To complete the transaction, the merchant returns information at block 234 to the discount coordinator specifying which discount the customer 104 selected and any modifications to the transaction resulting from application of the discount. The discount coordinator 104 effects communications to finalize the execution of the transaction with the applied discount by transmitting a modified transaction amount to the credit provider at block 236 and by initiating settlement of the selected discount at block 238. The credit provider may then apply the actual transaction amount to its records to have an accurate indication of the credit balance available to the customer 104 for future transactions. Settlement of the discount may include notifying the source of the selected discount, whether it be a manufacturer, merchant, credit provider, or other party, of its application, and additionally by initiating funds transfers to accommodate the application of the discount. For example, if the selected discount originates with a manufacturer, the manufacturer may be responsible for payment of the discount amount to the merchant who reduced the transaction cost to the customer 104. It is generally expected that there may be large numbers of small amounts to be paid in accordance with the application of such discounts so that settlement may advantageously proceed as a batch process performed at periodic intervals, such as once a day. This allows the discount coordinator to determine a much smaller set of funds transfers among the various parties that will account for the amounts owed in applying multiple discounts over the periodic time interval.

In other embodiments, the customer 104 may benefit from the application of multiple discounts simultaneously, as reflected by the flow diagram of FIG. 2C. In these embodiments, the discount coordinator identifies at block 240 that multiple of the possible discounts may be applied simultaneously, such as when each of the discounts originates with a different party, but none of the parties has any restrictions on its discount being combined with other available discounts. In such an embodiment, the discount coordinator may determine itself what total amount is to be discounted from the transaction cost, returning a modified transaction amount to the merchant at block 242. The merchant completes the transaction for the modified transaction amount at block 244, usually also notifying the customer 104 of the discounts that benefited the customer 104 by reducing the total transaction amount. Similar to the functions described in connection with FIG. 2B to finalize execution of the transaction, the discount coordinator transmits a modified transaction amount to the credit provider at block 246 and initiates settlement of the multiple discounts at block 248. The settlement may conveniently be performed as a periodic batch function to accommodate the transfer of multiple discount amounts among the various parties efficiently.

In still other embodiments, the discount coordinator itself may perform an analysis of the possible discounts to identify automatically which discount(s) would be most advantageous to the customer 104. Usually the advantageousness is evaluated to minimize the cost of the particular transaction, although other criteria may be applied in different embodiments. For instance, there may be embodiments in which the selection of a particular discount will satisfy criteria that will make the customer 104 eligible for future discounts that will be larger than other available reductions in the current transaction amount. This aspect of the invention is illustrated in FIG. 2D, but is similar to the embodiment of FIG. 2C in that the discount amount is generally determined by the discount coordinator as an automated function, with other parties acting in accordance with that determination. Thus, at block 250, the discount coordinator identifies the most advantageous discount as defined by relevant rules and returns the modified transaction amount to the merchant at block 252. The merchant then completes the transaction for the modified transaction cost at block 254, with the discount coordinator finalizing execution of the transaction by transmitting the modified transaction amount to the credit provider at block 256 and by initiating settlement of the discount at block 258. As for the previous embodiments, such settlement may be initiated on a periodic basis as a batch process to proceed more efficiently.

Similar types of transaction processes may be available when the presentation instrument is a specially issued discount instrument, as summarized by the flow diagram of FIG. 3. In each of these embodiments, the customer obtains the discount instrument by purchasing it, usually from the discount coordinator as indicated at block 304 but perhaps from another party in other embodiments. The cost of the specially issued discount instrument is usually expected to be less than the total value of discounts that might be obtained through participation in the discount arrangement. Thus, when the customer wishes to make use of the discount arrangement, she selects goods and/or services for purchase from a merchant at block 308 and presents the discount instrument at block 312. Since the discount instrument does not have dual functionality as a payment instrument in this embodiment, a determination of which discounts are to be applied is preferably performed before effecting payment for the transaction. In other embodiments, however, payment may be made before or simultaneous with determining which discounts to apply, with refunds or credits being made to the customer to provide the discounts. Thus, at block 316, the merchant transmits transaction information to the discount coordinator, permitting the discount coordinator to identify a plurality of possible discounts that may be applied to the transaction at block 320. As previously noted in connection with FIG. 2A, this identification may make use of information provided by the various communications capabilities of the discount-coordinator host system 104 in tracking manufacturer discounts, merchant discounts, credit-provider discounts, and the like.

The left column of FIG. 3 is applicable when the customer selects one or more discounts from the plurality of possible discounts identified by the discount coordinator at block 320. This may be done in an embodiment by the discount-coordinator host system 104 transmitting a list of possible discounts to the merchant at block 324, permitting the merchant to display a list of the possible discounts to the customer at block 328. After the customer makes a selection of a desired discount from the list at block 332, the merchant may return an identification of the selection to the discount coordinator at block 336.

The center column is applicable when the discount coordinator identifies multiple of the possible discounts that may permissibly be applied simultaneously, as indicated at block 340. The discount coordinator initiates application of these multiple discounts by returning modified transaction information back to the merchant at block 344. The modified transaction information may specify such information as a new total transaction cost and a list of which discounts have been applied so that they may be communicated to the customer.

The right column is applicable when a selection of one or more discounts to be applied is made by the discount coordinator. At block 348, the discount coordinator identifies the discount that is most advantageous to the customer using a rules-based methodology. Usually this methodology will identify the discount that lowers the total transaction cost by the greatest amount to be the most “advantageous,” but as previously mentioned in connection with FIG. 2D, there may be other rules that identify other discounts as more advantageous under certain circumstances. At block 352, the discount coordinator returns modified transaction information to the merchant, specifying such information as a new total transaction cost and an identification of the discount that has been applied so that it may be communicated to the customer.

Irrespective of which column is implemented in accordance with different embodiments of the invention, both the merchant and the discount coordinator have full knowledge of the transaction that is to be executed as modified by the application of one or more discounts. The merchant accordingly applies the discount to the transaction at block 356, collecting payment from the customer. Such payment could be in any form normally used for the execution of transactions, including cash, check, credit card, debit card, and the like. In the case of credit or debit transactions, execution of the transaction may involve seeking an authorization for transaction for the discounted transaction amount. The authorization request could then be routed through normal channels as is known in the art, or could be routed through the discount coordinator to make use of the interconnectivity available to the discount coordinator host system 104 in routing transaction information. As a parallel process, the discount coordinator initiates settlement of the applied discount(s) at block 360, usually by using a periodic batch process as described above to do so efficiently.

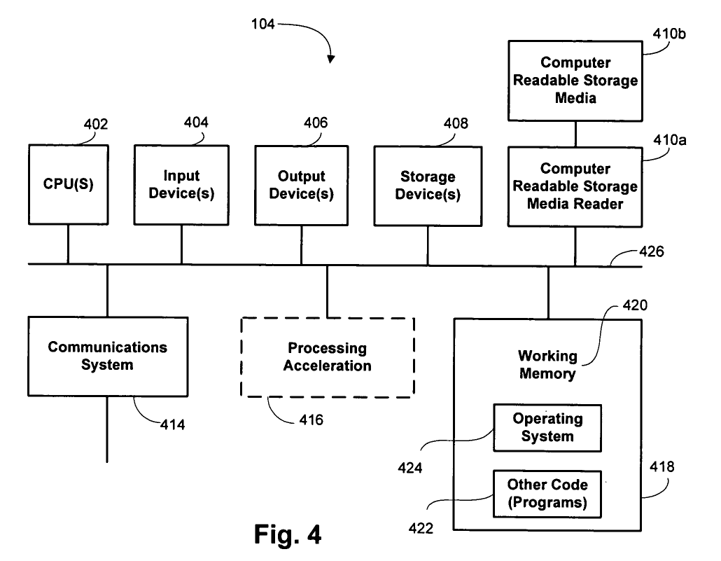

A structure that may be used in some embodiments for the discount-coordinator host system 104 is shown schematically in FIG. 4. A similar structure may be used for other host and system components of FIG. 1, including for the merchant hosts 116, the credit-card host systems 152, the manufacturer systems 148, systems used by the financial institutions 160, etc. FIG. 4 broadly illustrates how individual system elements may be implemented in a separated or more integrated manner. The discount-coordinator host system 104 is shown comprised of hardware elements that are electrically coupled via bus 426. In this embodiment, these hardware elements include one or more processors 402, one or more input devices 404, one or more output devices 406, one or more storage devices 408, a computer-readable storage media reader 410a, a communications system 414, a processing acceleration unit 416 such as a DSP or special-purpose processor, and a memory 418. The computer-readable storage media reader 410a is further connected to a computer-readable storage medium 410b, the combination comprehensively representing remote, local, fixed, and/or removable storage devices plus storage media for temporarily and/or more permanently containing computer-readable information. The communications system 414 may comprise a wired, wireless, modem, and/or other type of interfacing connection and permits data to be exchanged with the discount-coordinator host system 104.

The discount-coordinator host system 104 also comprises software elements, shown as being currently located within working memory 420, including an operating system 424 and other code 422, such as a program designed to implement methods of the invention. It will be apparent to those skilled in the art that substantial variations may be used in accordance with specific requirements. For example, customized hardware might also be used and/or particular elements might be implemented in hardware, software (including portable software, such as applets), or both. Further, connection to other computing devices such as network input/output devices may be employed.

It will be appreciated that the description of the discount-coordinator host system 104 herein is illustrative. The components described herein may be modified or varied, and more or fewer components may be used. Based on the disclosure and teachings herein, those of ordinary skill in the art will recognize other ways and/or methods of implementing the present invention. More generally, while the invention has been described with respect to exemplary embodiments, one skilled in the art will recognize that numerous modifications are possible. Accordingly, the above description should not be taken as limiting the scope of the invention, which is defined in the following claims.

What is claimed is:

1. A method for providing a discount to a transaction executed between a customer and a merchant for a purchase of goods and/or services, the method comprising:
receiving, at a host system, an electronic information packet that (1) includes an identifier of a credit instrument presented by the customer to the merchant and registered with the host system and (2) includes transaction information identifying at least some of the goods and/or services;
transmitting an authorization request from the host system to a credit provider associated with the credit instrument;
receiving, with the host system, an approval for the transaction from the credit provider;
transmitting, with the host system, the approval to the merchant;
identifying, with the host system and from the identifier, a plurality of separate discounts available for application to the transaction for the customer; and
coordinating between the host system and the merchant a modified transaction having a total transaction cost reduced by application of at least one of the plurality of separate discounts available for application to the transaction.

2. The method recited in claim 1 wherein coordinating the modified transaction comprises:
transmitting a list of the plurality of separate discounts from the host system to the merchant for display to the customer;
receiving a selection by the customer of one of the plurality of separate discounts; and
calculating, with the host system, the total transaction cost reduced by the selected discount.

3. The method recited in claim 1 wherein coordinating the modified transaction comprises:
identifying, with the host system, one of the plurality of separate discounts as most advantageous for the customer among the plurality of separate discounts; and
calculating, with the host system, the total transaction cost reduced by the identified one of the plurality of discounts.

4. The method recited in claim 3 wherein the most advantageous discount reduces the total transaction cost by a greater amount than any others of the plurality of separate discounts.

5. The method recited in claim 1 wherein coordinating the modified transaction comprises:
identifying, with the host system, multiple of the plurality of separate discounts eligible for simultaneous application; and
calculating, with the host system, the total transaction cost reduced by the identified multiple discounts.

6. The method recited in claim 1 wherein the at least one of the plurality of separate discounts comprises a discount offered by the merchant.

7. The method recited in claim 1 wherein the at least one of the plurality of separate discounts comprises a discount offered by a manufacturer of one of the goods and/or services.

8. The method recited in claim 1 further comprising initiating, with the host system, settlement of the at least one of the separate discounts by initiating a funds transfer to compensate the merchant for application of the at least one of the separate discounts to the transaction.

9. The method recited in claim 8 wherein initiating settlement of the at least one of the separate discounts is performed as part of a batch process initiating settlement of discounts for a plurality of transactions between a plurality of customers and a plurality of merchants.

10. A method for providing a discount to a transaction executed between a customer and a merchant for a purchase of goods and/or services, the method comprising:
receiving, at a host system operated by a discount coordinator, an electronic information packet that (1) includes an identifier of a discount instrument presented by the customer to the merchant and purchased for a fee from the discount coordinator and (2) includes transaction information identifying at least some of the goods and/or services;
identifying, with the host system and from the identifier, a plurality of separate discounts available for application to the transaction for the customer; and
coordinating between the host system and the merchant a modified transaction having a total transaction cost reduced by application of at least one of the plurality of separate discounts available for application to the transaction.

11. The method recited in claim 10 wherein coordinating the modified transaction comprises:
transmitting a list of the plurality of separate discounts from the host system to the merchant for display to the customer;
receiving a selection by the customer of one of the plurality of separated discounts; and
calculating, with the host system, the total transaction cost reduced by the selected discount.

12. The method recited in claim 10 wherein coordinating the modified transaction comprises:
identifying, with the host system, one of the plurality of separate discounts as most advantageous for the customer among the plurality of separate discounts; and
calculating, with the host system, the total transaction cost reduced by the identified one of the plurality of discounts.

13. The method recited in claim 12 wherein the most advantageous discount reduces the total transaction cost by a greater amount than any others of the plurality of separate discounts.

14. The method recited in claim 10 wherein coordinating the modified transaction comprises:
identifying, with the host system, multiple of the plurality of separate discounts eligible for simultaneous application; and
calculating, with the host system, the total transaction cost reduced by the identified multiple discounts.

15. The method recited in claim 10 wherein the at least one of the plurality of separate discounts comprises a discount offered by the merchant.

16. The method recited in claim 10 wherein the at least one of the plurality of separate discounts comprises a discount offered by a manufacturer of one of the goods and/or services.

17. The method recited in claim 10 further comprising initiating, with the host system, settlement of the at least one of the separate discounts by initiating a finds transfer to compensate the merchant for application of the at least one of the separate discounts to the transaction.

18. The method recited in claim 17 wherein initiating settlement of the at least one of the separate discounts is performed as part of a batch process initiating settlement of discounts for a plurality of transactions between a plurality of customers and a plurality of merchants.

19. A method for providing a discount to a transaction executed between a customer and a merchant for a purchase of goods and/or services, the method comprising:
receiving, at a host system, an electronic information packet that (1) includes an identifier of a credit instrument presented by the customer and registered with the host system and (2) includes transaction information identifying at least some of the goods and/or services;
identifying, with the host system and from the identifier, a credit provider associated with the credit instrument;
transmitting an authorization request from the host system to the credit provider;
receiving, with the host system, an approval for the transaction from the credit provider;
transmitting, with the host system, the approval to the merchant;
identifying, with the host system and from the identifier, a plurality of separate discounts available for application to the transaction for the customer;
determining that one of the plurality of separate discounts will reduce a total transaction cost for the transaction by a greater amount than any others of the plurality of separate discounts;
transmitting modified transaction information from the host system to the merchant for a modified transaction with the one of the plurality of separate discounts applied to the transaction;
transmitting a modified transaction cost from the host system to the credit provider for application to a credit account of the customer; and
initiating settlement of the one of the plurality of separate discounts by initiating a finds transfer to compensate the merchant for application of the at least one of the separate discounts to the transaction.

20. A host system comprising:
a communications device;
a storage device;
a processor in communication with the communications device and the storage device; and
a memory coupled with the processor, the memory comprising a computer-readable storage medium having a computer-readable program embodied therein for operating the host system to provide a discount to a transaction executed between a customer and a merchant for a purchase of goods and/or services, the computer-readable program including:
instructions for receiving with the communications device an electronic information packet that (1) includes an identifier of a credit instrument presented by the customer and registered with the host system and (2) includes transaction information identifying at least some of the goods and/or services;
instructions for transmitting with the communications device an authorization request from the host system to a credit provider associated with the credit instrument;
instructions for receiving with the communications device an approval for the transaction from the credit provider;
instructions for transmitting with the communications device the approval to the merchant;
instructions for identifying with the processor and from the identifier, a plurality of separate discounts available for application to the transaction for the customer; and
instructions for coordinating between the host system and the merchant a modified transaction having a total transaction cost reduced by application of at least one of the plurality of separate discounts available for application to the transaction.

21. A host system comprising:
a communications device;
a storage device;
a processor in communication with the communications device and the storage device; and
a memory coupled with the processor, the memory comprising a computer-readable storage medium having a computer-readable program embodied therein for operating the host system to provide a discount to a transaction executed between a customer and a merchant for a purchase of goods and/or services, the computer-readable program including:
instructions for receiving with the communications device, an electronic information packet that (1) includes an identifier of a discount instrument presented by the customer and purchased for a fee from a discount coordinator and (2) includes transaction information identifying at least some of the goods and/or services;
instructions for identifying with the processor and from the identifier, a plurality of separate discounts available for application to the transaction for the customer; and
instructions for coordinating between the host system and the merchant a modified transaction having a total transaction cost reduced by application of at least one of the plurality of separated discounts available for application to the transaction.
